(19) United States
(12) Patent Application Publication
(10) Pub. No.: US 2026/0072260 A1
(43) Pub. Date: Mar. 12, 2026

(54) WIDE-ANGLE OPTICAL SYSTEM AND OPTICAL DEVICE

(71) Applicant: Shenzhen HSOT Optoelectronic Technology Co., Ltd., Shenzhen (CN)

(72) Inventors: Yao LONG, Shenzhen (CN); Tao LAI, Shenzhen (CN)

(73) Assignee: Shenzhen HSOT Optoelectronic Technology Co., Ltd., Shenzhen (CN)

(21) Appl. No.: 18/826,544

(22) Filed: Sep. 6, 2024

(51) Int. Cl. G02B 17/08; G02B 13/06

(52) U.S. Cl. CPC G02B 17/0824; G02B 13/06

(57) ABSTRACT

Disclosed are a wide-angle optical system and an optical device. The first lens includes a first mirror surface and a second mirror surface, the first mirror surface is a convex surface, and the second mirror surface is a concave surface; the second lens includes a third mirror surface and a fourth mirror surface, and both the third mirror surface and the fourth mirror surface are convex surfaces; the third lens includes a fifth mirror surface and a sixth mirror surface, and both the fifth mirror surface and the sixth mirror surface are convex surfaces; the fourth lens includes a seventh mirror surface and an eighth mirror surface, the seventh mirror surface is a concave surface, and the eighth mirror surface is a convex surface.

### TECHNICAL FIELD

The present application relates to the technical field of optical technology, and in particular to a wide-angle optical system and an optical device.

### BACKGROUND

Currently, most photographic lenses use Cooke three-piece test and its improved structure. In the improved model of ultra-wide-angle camera, at least six lenses are usually used in the camera structure. The structure design is complex, the volume is large, which is difficult to debug spherical aberration, convergence aberration, astigmatism, chromatic aberration, etc., and the cost is high. Therefore, the price of ultra-wide-angle cameras on the market remains high.

### SUMMARY

The main purpose of the present application is to provide a wide-angle optical system and an optical device, aiming to solve the technical problems of the wide-angle camera lens in the related art, which is complex in structure, difficult and costly in the debugging process.

To achieve the above purpose, the present application provides a wide-angle optical system, including: a camera; and an optoelectric sensor; the camera includes a first lens, a second lens, a third lens and a fourth lens provided in sequence; the first lens includes a first mirror surface and a second mirror surface, the first mirror surface is a convex surface, and the second mirror surface is a concave surface; the second lens includes a third mirror surface and a fourth mirror surface, and both the third mirror surface and the fourth mirror surface are convex surfaces; the third lens includes a fifth mirror surface and a sixth mirror surface, and both the fifth mirror surface and the sixth mirror surface are convex surfaces; the fourth lens includes a seventh mirror surface and an eighth mirror surface, the seventh mirror surface is a concave surface, and the eighth mirror surface is a convex surface; the optoelectric sensor is provided on one side of the eighth mirror surface, a light beam is incident from the first mirror surface into the first lens and configured to pass through the second mirror surface, the third mirror surface, the fourth mirror surface, the fifth mirror surface, the sixth mirror surface, the seventh mirror surface, and the eighth mirror surface in sequence to be incident on the optoelectric sensor; the first lens is a negative lens, the second lens is a positive lens, the third lens is a positive lens, and the fourth lens is a negative lens; and an angle of view field of the camera is 180 degrees to 190 degrees, a relative aperture is 2.0 to 2.8, a diffuse spot diameter is less than 5 μ m, and a relative transmittance is greater than 50%.

In an embodiment, an aperture of the first mirror surface is 8 mm to 10 mm, an aperture of the second mirror surface is 4.2 mm to 5 mm, an aperture of the third mirror surface is 2 mm to 2.6 mm, an aperture of the fourth mirror surface is 2.4 mm to 3.1 mm, an aperture of the fifth mirror surface is 3 mm to 3.9 mm, an aperture of the sixth mirror surface is 3.1 mm to 3.7 mm, an aperture of the seventh mirror surface is 3.3 mm to 3.7 mm, and an aperture of the eighth mirror surface is 3.5 mm to 4.1 mm.

In an embodiment, a radius of curvature of the first mirror surface is 43 to 44.5, a radius of curvature of the second mirror surface is 2 to 3, a radius of curvature of the third mirror surface is 7.2 to 8, a radius of curvature of the fourth mirror surface is 7.2 to 8, a radius of curvature of the fifth mirror surface is 6.5 to 7.5, a radius of curvature of the sixth mirror surface is 2.2 to 3.1, a radius of curvature of the seventh mirror surface is 2.2 to 3, and a radius of curvature of the eighth mirror surface is 36 to 41.

In an embodiment, a thickness of the first lens is 0.4 mm to 0.8 mm, a spacing between the second mirror surface and the third mirror surface is 5.5 mm to 6 mm, a thickness of the second lens is 3.7 mm to 4.5 mm, a spacing between the fourth mirror surface and the fifth mirror surface is 0.02 mm to 0.15 mm, a thickness of the third lens is 2 mm to 2.8 mm, and a thickness of the fourth lens is 0.3 mm to 0.8 mm; and a convex shape of the sixth mirror surface is matched with a concave shape of the seventh mirror surface, and the sixth mirror surface is fitted with the seventh mirror surface.

In an embodiment, a refractive index of the first lens is 1.68 to 1.71, a refractive index of the second lens is 1.75 to 1.79, a refractive index of the third lens is 1.68 to 1.71, and a refractive index of the fourth lens is 1.83 to 1.86; and a dispersion coefficient of the first lens is 54 to 56, a dispersion coefficient of the second lens is 48 to 52, a dispersion coefficient of the third lens is 54 to 56, and a dispersion coefficient of the fourth lens is 22 to 24.

In an embodiment, all of Abbe numbers of the first lens, the second lens, the third lens, and the fourth lens are greater than 60.

In an embodiment, the wide-angle optical system further includes a protective sheet provided on one side of the first lens away from the second lens; an imaging band of the protective sheet is 450 nm to 940 nm.

In an embodiment, the wide-angle optical system further includes: a shell provided with an accommodation chamber, all of the optoelectric sensor, the first lens, the second lens, the third lens and the fourth lens are provided in the accommodation chamber, and optical axes of the first lens, the second lens, the third lens and the fourth lens are overlapped.

In an embodiment, the wide-angle optical system further includes a rotating member connected to the shell, and the rotating member is configured to drive the camera and the optoelectric sensor to rotate synchronously.

The present application also provides an optical device including the wide-angle optical system.

The camera in the technical solution of the present application is composed of only four lenses, which greatly reduces the overall size of the camera. The angle of view field of the camera is 180 degrees to 190 degrees, the relative aperture is 2.0 to 2.8, the diameter of the diffuse spot is less than 5 μm, and the relative transmittance is greater than 50%. By reducing the number of lenses, the spherical aberration, the coma, the astigmatism, and the chromatic aberration, etc. can be effectively corrected, reducing the difficulty of debugging and reducing production costs.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a wide-angle optical system according to an embodiment of the present application.

FIG. 2 is a modulation transfer function (MTF) curve view of a camera objective optical system in FIG. 1.

FIG. 3 is a point array view of the camera objective optical system in FIG. 1.

FIG. 4 is a light aberration view of the camera objective optical system in FIG. 1.

FIG. 5 is a left field curvature view and a right distortion view of the camera objective optical system in FIG. 1.

FIG. 6 is a relative illumination view of the camera objective optical system in FIG. 1.

The realization of the objective, functional characteristics, and advantages of the present application are further described with reference to the accompanying drawings.

### DETAILED DESCRIPTION OF THE EMBODIMENTS

In order to illustrate the purpose, technical solutions and advantages of the present application, the following briefly introduces the accompanying drawings required for the description of the embodiments. Obviously, the embodiments in the following description are only part of the present application. All other embodiments obtained by those skilled in the art based on the embodiments of the present application without creative efforts shall fall within the scope of the present application.

It should be noted that if there are directional indications (such as up, down, left, right, front, back.) in the present application embodiment, they are only used to explain the relative position relationship and motion between the components in a specific attitude. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the present application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

The present application provides a wide-angle optical system and an optical device. The wide-angle optical system includes a camera and an optoelectric sensor 50. The camera includes a first lens 10, a second lens 20, a third lens 30, and a fourth lens 40 provided in sequence. The first lens 10 includes a first mirror surface 11 and a second mirror surface 12. The first mirror surface 11 is a convex surface, and the second mirror surface 12 is a concave surface. The second lens 20 includes a third mirror surface 21 and a fourth mirror surface 22. The third mirror surface 21 and the fourth mirror surface 22 are both convex surfaces. The third lens 30 includes a fifth mirror surface 31 and a sixth mirror surface 32. The fifth mirror surface 31 and the sixth mirror surface 32 are both convex surfaces. The fourth lens 40 includes a seventh mirror surface 41 and an eighth mirror surface 42. The seventh mirror surface 41 is a concave surface, and the eighth mirror surface 42 is a convex surface.

The optoelectric sensor 50 is provided on one side of the eighth mirror surface 42. The light beam is incident on the first lens 10 from the first mirror surface 11, and passes through the second mirror surface 12, the third mirror surface 21, the fourth mirror surface 22, the fifth mirror surface 31, the sixth mirror surface 32, the seventh mirror surface 41, and the eighth mirror surface 42 in sequence until it is incident on the optoelectric sensor 50.

The angle of view field of the camera is 180 degrees to 190 degrees, the relative aperture is 2.0 to 2.8, the diffuse spot diameter is less than 5 μu, and the relative light transmission is greater than 50%.

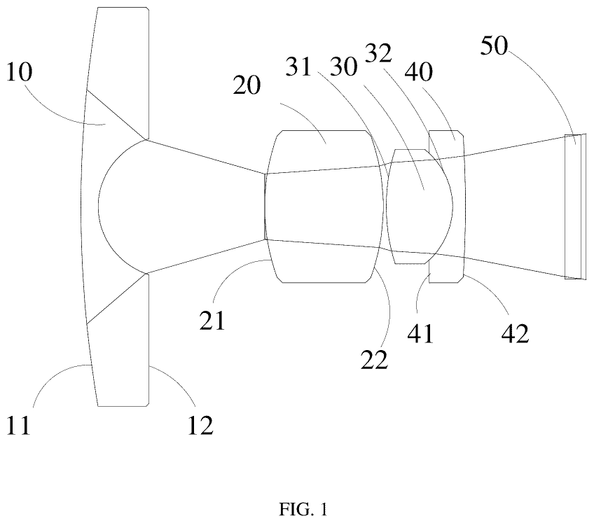

In an embodiment, four lenses are provided to achieve ultra-wide-angle shooting, and the structure is simple. The first lens 10 is an objective lens, referring to FIG. 1, the first mirror surface 11 is on the left side of first lens 10, and the first mirror surface 11 is towards the object side. The second mirror surface 12, the third mirror surface 21 . . . and the eighth mirror surface 42 are provided from left to right.

The light beam on the object side passes through the first lens 10, the second lens 20, the third lens 30 and the fourth lens 40 in sequence to reach the optical sensor, thereby forming an image on the optical sensor.

The first mirror surface 11 is a convex surface to the left, the second mirror surface 12 is a concave surface to the left, the third mirror surface 21 is a convex surface to the left, the fourth mirror surface 22 is a convex surface to the right, the fifth mirror surface 31 is a convex surface to the left, the sixth mirror surface 32 is a convex surface to the right, the seventh mirror surface 41 is a concave surface to the right, and the eighth mirror surface 42 is a convex surface to the right.

The second lens 20 and the third lens 30 both use a double-sided convex lens to deflect the light at a large angle, thereby shortening the focus position of the light. The eighth mirror surface 42 also uses the convex surface to converge the light beam and further adjust the propagation path of the light beam to ensure clear imaging on the image side.

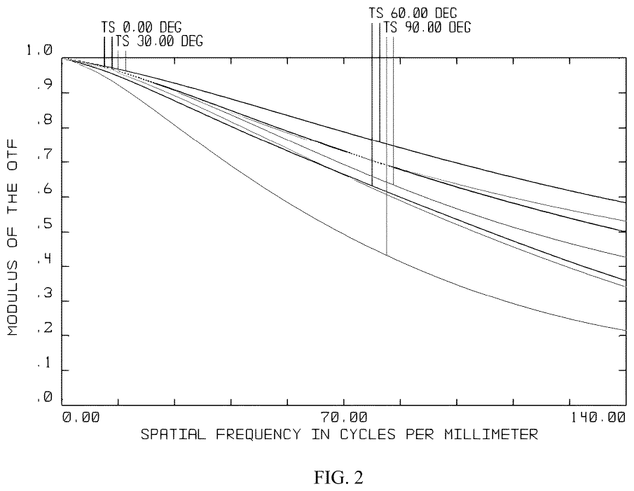

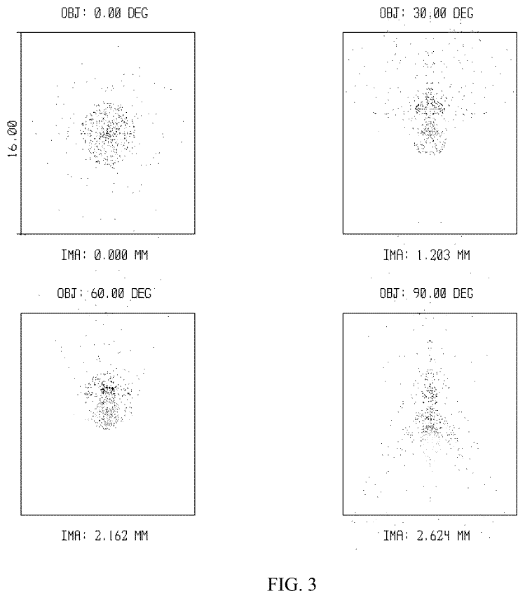

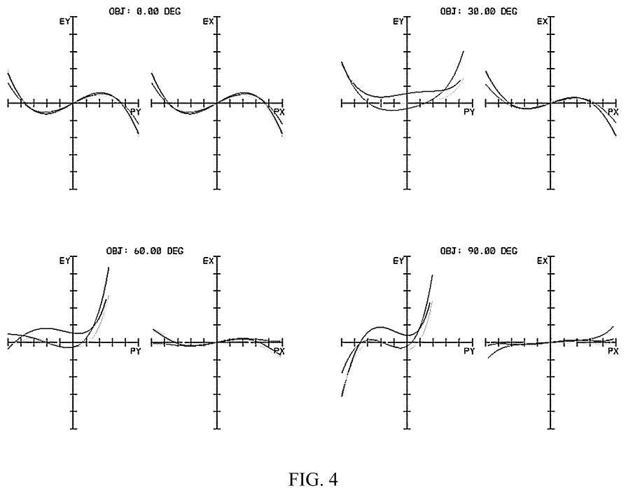

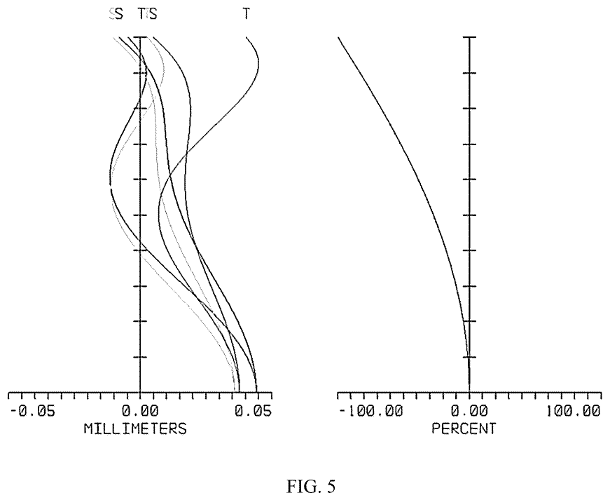

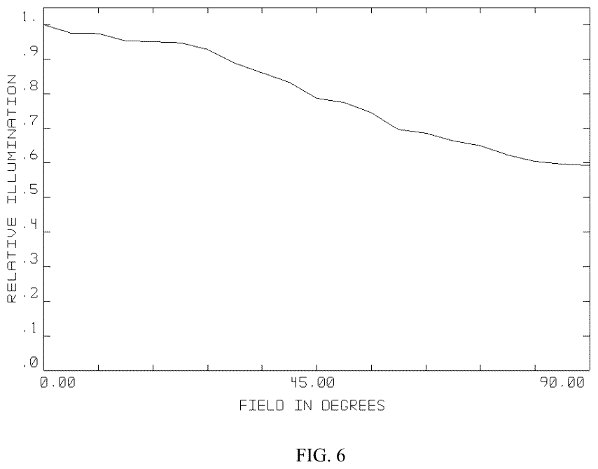

The first lens 10 is a negative lens, the second lens 20 is a positive lens, the third lens 30 is a positive lens, and the fourth lens 40 is a negative lens, which corrects the spherical aberration, the coma, the astigmatism, and the chromatic aberration, etc. The effective angle of view field reaches ±90 degrees, and has good image quality within ±90 degrees. FIG. 2, FIG. 3, FIG. 4, FIG. 5 and FIG. 6 illustrate the simulation effect of imaging parameters in this embodiment.

The camera in the technical solution of the present application is composed of only four lenses, which greatly reduces the overall size of the camera. The angle of view field of the camera is 180 degrees, the relative aperture is 2.0 to 2.8, the diffuse spot diameter is less than 5 μ m, and the relative light transmission is greater than 50%. By reducing the number of lenses, the spherical aberration, the coma, the astigmatism, and the chromatic aberration, etc. can also be effectively corrected, reducing the difficulty of debugging and reducing production costs.

In an embodiment, the aperture of the first mirror surface 11 is 8 mm to 10 mm, the aperture of the second mirror surface 12 is 4.2 mm to 5 mm, the aperture of the third mirror surface 21 is 2 mm to 2.6 mm, the aperture of the fourth mirror surface 22 is 2.4 mm to 3.1 mm, the aperture of the fifth mirror surface 31 is 3 mm to 3.9 mm, the aperture of the sixth mirror surface 32 is 3.1 mm to 3.7 mm, the aperture of the seventh mirror surface 41 is 3.3 mm to 3.7 mm, and the aperture of the eighth mirror surface 42 is 3.5 mm to 4.1 mm.

In an embodiment, the apertures of the first mirror surface 11 to the eighth mirror surface 42 are respectively set to 8.4 mm, 4.8 mm, 2.2 mm, 2.8 mm, 3.4 mm, 3.4 mm, 3.6 mm, and 3.8 mm. The overall size of the camera is greatly reduced, which is suitable for mass production with a low cost. Through the above parameters, the spherical aberration, the coma, the astigmatism, and the chromatic aberration, etc. can be corrected, and better image quality can be presented within ±90 degrees.

In an embodiment, the radius of curvature of the first mirror surface 11 is 43 to 44.5, the radius of curvature of the second mirror surface 12 is 2 to 3, the radius of curvature of the third mirror surface 21 is 7.2 to 8, the radius of curvature of the fourth mirror surface 22 is 7.2 to 8, the radius of curvature of the fifth mirror surface 31 is 6.5 to 7.5, the radius of curvature of the sixth mirror surface 32 is 2.2 to 3.1, the radius of curvature of the seventh mirror surface 41 is 2.2 to 3, and the radius of curvature of the eighth mirror surface 42 is 36 to 41.

In an embodiment, the radius of curvature of the first mirror surface 11 is 43.9352, the radius of curvature of the second mirror surface 12 is 2.584, the radius of curvature of the third mirror surface 21 is 7.758, the radius of curvature of the fourth mirror surface 22 is 7.758, the radius of curvature of the fifth mirror surface 31 is 7.096, the radius of curvature of the sixth mirror surface 32 is 2.673, the radius of curvature of the seventh mirror surface 41 is 2.673, and the radius of curvature of the eighth mirror surface 42 is 39.303.

It should be noted that since the radius of curvature of the first mirror surface 11 is relatively large and the first mirror surface 11 is the convex surface, the surface of the first mirror surface 11 is relatively flat, so that it does not affect the installation of a protective sheet in front of the first mirror surface 11.

In an embodiment, the wide-angle optical system further includes a protective sheet, which is provided on the side of the first lens 10 away from the second lens 20. The imaging band of the protective sheet is 450 nm to 650 nm, or in special cases, the imaging band of the protective sheet can be extended to 940 nm.

In an embodiment, referring to FIG. 1, the thickness of the first lens 10 is 0.4 mm to 0.8 mm, the distance between the second mirror surface 12 and the third mirror surface 21 is 5.5 mm to 6 mm, the thickness of the second lens 20 is 3.7 mm to 4.5 mm, the distance between the fourth mirror surface 22 and the fifth mirror surface 31 is 0.02 mm to 0.15 mm, the thickness of the third lens 30 is 2 mm to 2.8 mm, and the thickness of the fourth lens 40 is 0.3 mm to 0.8 mm. The convex shape of the sixth mirror surface 32 is matched with the concave shape of the seventh mirror surface 41, and the sixth mirror surface 32 is fitted with the seventh mirror surface 41.

In an embodiment, the thickness of the first lens 10 is 0.6 mm, the distance between the second mirror surface 12 and the third mirror surface 21 is 5.8 mm, the thickness of the second lens 20 is 4.1 mm, the distance between the fourth mirror surface 22 and the fifth mirror surface 31 is 0.1 mm, the thickness of the third lens 3030 is 2.3 mm, the sixth mirror surface 32 is attached to the seventh mirror surface 41, and the thickness of the fourth lens 4040 is 0.45 mm.

The thickness of the lens refers to the wall thickness of the lens at the position of its optical axis or central axis.

In an embodiment, the refractive index of the first lens 10 is 1.68 to 1.71, the refractive index of the second lens 20 is 1.75 to 1.79, the refractive index of the third lens 30 is 1.68 to 1.71, and the refractive index of the fourth lens 40 is 1.83 to 1.86. The dispersion coefficient of the first lens 10 is 54 to 56, the dispersion coefficient of the second lens 20 is 48 to 52, the dispersion coefficient of the third lens 30 is 54 to 56, and the dispersion coefficient of the fourth lens 40 is 22 to 24.

By utilizing the material characteristics, the first lens 10, the second lens 20, the third lens 30 and the fourth lens 40 are prepared as high refractive index lenses, and the dispersion coefficient of the lenses is controlled to achieve high Abbe number and high refractive index lenses. The Abbe numbers of the first lens 10, the second lens 20, the third lens 30 and the fourth lens 40 are greater than 60.

In an embodiment, the wide-angle optical system further includes a shell provided with an accommodation chamber. The optoelectric sensor 50, the first lens 10, the second lens 20, the third lens 30 and the fourth lens 40 are all provided in the accommodation chamber. The optical axes of the first lens 10, the second lens 20, the third lens 30 and the fourth lens 40 are overlapped.

The first lens 10, the second lens 20, the third lens 30 and the fourth lens 40 are fixed in the shell, and the optical axes of the first lens 10, the second lens 20, the third lens 30 and the fourth lens 40 are kept on the same straight line through the limiting effect of the shell, so as to prevent the light beam from deviating when passing through different lenses and causing unclear imaging.

In this embodiment, in order to further improve the convenience of use and wide adaptability, an adjusting block can be provided on the shell, and the position of the adjusting block corresponds to the position of the lens. The first lens 10 to the fourth lens 40 are each provided with the adjusting block. By pressing the adjusting block, the position of the lens in the shell can be adjusted to adjust the optical axis position of the lens.

In an embodiment, the wide-angle optical system also includes a rotating member connected to the shell, and the rotating member is configured to drive the camera and the optoelectric sensor 50 to rotate synchronously.

The rotating member can be connected to the shell in a gear rotation manner. When in use, the shell can be fixed, and the shell can be rotated by the rotating member to adjust the imaging position to ensure that the first lens 10 is aligned with the object side. It is suitable for installation in a space with a relatively narrow space, such as a cat's eye, or a notebook and other devices.

In addition, to solve the above problems, the present application also provides an optical device, which is equipped with the wide-angle optical system as described above. The optical system can be, for example, a camera, a camera group, etc.

It is composed of four lenses, and the aperture of each lens from the object side to the image side is 8.4 mm, 4.8 mm, 2.2 mm, 2.8 mm, 3.4 mm, 3.4 mm, 3.6 mm, and 3.8 mm respectively. The overall size of the optical device is greatly reduced, which is suitable for mass production and low cost. Through the above parameters, the spherical aberration, the coma, the astigmatism, and the chromatic aberration, etc. can be corrected, and better image quality can be presented within ±90 degrees. Therefore, the structure of the present application is small in size and can be applied to devices such as cat eyes of security doors or home monitoring.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

1. A wide-angle optical system, comprising:
a camera; and
an optoelectric sensor, wherein:
the camera comprises a first lens, a second lens, a third lens and a fourth lens provided in sequence;
the first lens comprises a first mirror surface and a second mirror surface, the first mirror surface is a convex surface, and the second mirror surface is a concave surface;
the second lens comprises a third mirror surface and a fourth mirror surface, and both the third mirror surface and the fourth mirror surface are convex surfaces;
the third lens comprises a fifth mirror surface and a sixth mirror surface, and both the fifth mirror surface and the sixth mirror surface are convex surfaces;
the fourth lens comprises a seventh mirror surface and an eighth mirror surface, the seventh mirror surface is a concave surface, and the eighth mirror surface is a convex surface;
the optoelectric sensor is provided on one side of the eighth mirror surface, a light beam is incident from the first mirror surface into the first lens and configured to pass through the second mirror surface, the third mirror surface, the fourth mirror surface, the fifth mirror surface, the sixth mirror surface, the seventh mirror surface, and the eighth mirror surface in sequence to be incident on the optoelectric sensor;
the first lens is a negative lens, the second lens is a positive lens, the third lens is a positive lens, and the fourth lens is a negative lens; and
an angle of view field of the camera is 180 degrees to 190 degrees, a relative aperture is 2.0 to 2.8, a diffuse spot diameter is less than 5 μ m, and a relative transmittance is greater than 50%.

2. The wide-angle optical system according to claim 1, wherein an aperture of the first mirror surface is 8 mm to 10 mm, an aperture of the second mirror surface is 4.2 mm to 5 mm, an aperture of the third mirror surface is 2 mm to 2.6 mm, an aperture of the fourth mirror surface is 2.4 mm to 3.1 mm, an aperture of the fifth mirror surface is 3 mm to 3.9 mm, an aperture of the sixth mirror surface is 3.1 mm to 3.7 mm, an aperture of the seventh mirror surface is 3.3 mm to 3.7 mm, and an aperture of the eighth mirror surface is 3.5 mm to 4.1 mm.

3. The wide-angle optical system according to claim 1, wherein a radius of curvature of the first mirror surface is 43 to 44.5, a radius of curvature of the second mirror surface is 2 to 3, a radius of curvature of the third mirror surface is 7.2 to 8, a radius of curvature of the fourth mirror surface is 7.2 to 8, a radius of curvature of the fifth mirror surface is 6.5 to 7.5, a radius of curvature of the sixth mirror surface is 2.2 to 3.1, a radius of curvature of the seventh mirror surface is 2.2 to 3, and a radius of curvature of the eighth mirror surface is 36 to 41.

4. The wide-angle optical system according to claim 3, wherein a thickness of the first lens is 0.4 mm to 0.8 mm, a spacing between the second mirror surface and the third mirror surface is 5.5 mm to 6 mm, a thickness of the second lens is 3.7 mm to 4.5 mm, a spacing between the fourth mirror surface and the fifth mirror surface is 0.02 mm to 0.15 mm, a thickness of the third lens is 2 mm to 2.8 mm, and a thickness of the fourth lens is 0.3 mm to 0.8 mm; and
a convex shape of the sixth mirror surface is matched with a concave shape of the seventh mirror surface, and the sixth mirror surface is fitted with the seventh mirror surface.

5. The wide-angle optical system according to claim 1, wherein a refractive index of the first lens is 1.68 to 1.71, a refractive index of the second lens is 1.75 to 1.79, a refractive index of the third lens is 1.68 to 1.71, and a refractive index of the fourth lens is 1.83 to 1.86; and
a dispersion coefficient of the first lens is 54 to 56, a dispersion coefficient of the second lens is 48 to 52, a dispersion coefficient of the third lens is 54 to 56, and a dispersion coefficient of the fourth lens is 22 to 24.

6. The wide-angle optical system according to claim 1, wherein all of Abbe numbers of the first lens, the second lens, the third lens, and the fourth lens are greater than 60.

7. The wide-angle optical system according to claim 1, further comprising:
a protective sheet provided on one side of the first lens away from the second lens,
wherein an imaging band of the protective sheet is 450 nm to 940 nm.

8. The wide-angle optical system according to claim 1, further comprising:
a shell provided with an accommodation chamber,
wherein all of the optoelectric sensor, the first lens, the second lens, the third lens and the fourth lens are provided in the accommodation chamber, and optical axes of the first lens, the second lens, the third lens and the fourth lens are overlapped.

9. The wide-angle optical system according to claim 8, further comprising:
a rotating member connected to the shell,
wherein the rotating member is configured to drive the camera and the optoelectric sensor to rotate synchronously.

10. An optical device, comprising the wide-angle optical system according to claim 1.
